(19) United States
(12) Patent Application Publication
(10) Pub. No.: US 2008/0091750 A1
(43) Pub. Date: Apr. 17, 2008

(54) WEB-BASED SECURED FORUM FOR COLLABORATIVE INVENTIONS CREATION

(75) Inventors: Wlodek W. ZADROZNY, Hawthorne, NY (US); Dimitri Kanevsky, Ossining, NY (US); Alexander Zlatsin, Yorktown Heights, NY (US)

Correspondence Address: THE FARRELL LAW FIRM, P.C., 333 EARLE OVINGTON BOULEVARD, SUITE 701, UNIONDALE, NY, 11553, US

(73) Assignee: International Business Machines Corporation, Armonk, NY (US)

(21) Appl. No.: 11/949,982

(22) Filed: Dec. 4, 2007

Related U.S. Application Data
(63) Continuation of application No. 09/615,351, filed on Jul. 12, 2000.

(51) Int. Cl. G06F 17/30

(52) U.S. Cl. 707/205; 707/E17.001

(57) ABSTRACT

A system and method for bringing together potential co-inventors, developing a patent proposal, negotiating for rights in a patent draft, and writing a patent draft. A subscriber list is created and kept in a Subscriber Database. A pool of potential co-inventors is created by a Patent Proposal Server, which stores a patent proposal file. A Patent Proposal Web Server provides a forum for the initial inventor and the pool of potential co-inventors to further develop the patent proposal. The patent proposal becomes a patent draft file on a Patent Draft Server and the pool of potential co-inventors and the initial inventor negotiate for rights in the patent draft by means of a Rights Negotiation Server. The pool of co-inventors and the initial inventor co-write the patent draft by means of a Patent Draft Web Server. A Security System maintains levels of security in the system.

### CROSS REFERENCE TO RELATED APPLICATION

This application is a continuation of application Ser. No. 09/615,351 filed Jul. 12, 2000, the contents of which are incorporated herein by reference.

### BACKGROUND OF THE INVENTION

1. Field of the Invention

This invention relates to a system and method of creating patent applications in general, and, in particular, to a system and method for forming a group of co-inventors, for developing and drafting a patent application through a collaborative effort, and for apportioning rights in the finished patent application.

2. Description of the Related Art

In the corporate atmosphere of the new millennium, intellectual property is becoming one of the most important assets a corporation possesses. Intellectual property, in the form of patents, trademarks, and copyrights, is both the support for future development, as well as the bulwark against competitor's products and practices. This invention focuses on the intellectual property of patents.

Writing a patent application is often a time-consuming and laborious process. Patent agents and attorneys are usually used for this purpose, which adds to the expense and difficulty. The difficulty in drafting a patent prevents laypeople, who may have very good ideas for inventions, from even attempting to patent their ideas. Even when a corporation has many creative individuals, it may not be realizing all of its potential assets. Thus, a corporation may be losing money from ideas that it might have patented or, even worse, may be allowing competitors to take possession of inventions for which personnel at the corporation might have had the idea first. Therefore, there is a need for a simplified system and method to develop and draft patent applications.

In addition, in a corporation, as an example, there may be individuals that don't know about a particular patent proposal, but whose abilities might be a perfect asset to the development of that patent proposal, as well as its subsequent writing. Outside the structure of a corporation, there may be disparate individuals whose skills would uniquely match them to a patent proposal, but there are no means for them to discover each other or to form a group. Therefore, there is a need for a system and method of bringing together individuals whose interests, skills, or experience are relevant to a particular patent proposal.

Besides the issue of forming a group with relevant skills, the work of developing and writing a patent application is a strenuous task for an individual. In addition, in a corporate environment, the task of preparing a patent application will take an employee away from her other duties and responsibilities. However, this task can be made easier by having more than one individual involved in the creative process, thereby distributing the burden. However, this distribution of the development and writing work presents problems. These co-writers will need to meet, share ideas, assign writing tasks to individuals, review, and revise. As the number of co-writers increases, the individual burden decreases, but the logistics of organizing face-to-face meetings and keeping everyone informed of all the changes increases in the same proportion. For people in a corporation, there is again the problem of time being taken away from the day-to-day work of the employees who are acting as co-writers. For individuals who are not connected by a corporation or even geographically, the logistics of organizing a group development effort may be insurmountable. Therefore, there is a need for a system to organize and simplify the interaction between co-writers who are writing a patent application.

On the other hand, even if the group of co-writers is effectively organized to write together, the issue of individual rights to the final product still needs to be addressed. If, in the end, the group of co-writers will retain their rights to the issued patent (rather than assigning them to an employer), they may wish to agree contractually beforehand as to what each member can do. For instance, they may decide to assign their rights to a company in which they are the only shareholders. Further, they may decide to apportion the number of shares given to each member according to that member's contribution to the project. If this is an invention that will be assigned to an employer for which all the co-writers work, the employer may have a policy of disbursing royalties, bonuses, or benefits to co-inventor/employees for valuable issued patents or for the number of filed patent applications. In this case, the group of co-writers may want to apportion these benefits according to the work or skill that each co-writer brought to the project. Therefore, there is a need to effectively apportion rights in the patent application or future issued patent amongst the various people working on it.

In summary, there is a need for a system and method for forming a group of co-writers, for organizing the group so that they may effectively collaborate on developing and writing a patent application, and for the group to negotiate concerning rights in the patent application or future issued patent.

### SUMMARY OF THE INVENTION

An object of this invention is to provide a system and method for creating a group of potential co-inventors, based on their interests, skills and experience.

Another object of the invention is to provide a system and method for simplifying and systematizing a procedure for drafting patent applications.

Another object of the invention is to provide a system and a method for a group of co-inventors to collaborate on developing and drafting a patent application.

Yet another object of the invention is to provide a system and method for collaborative drafting of a patent application over a network.

A further object of the invention is to provide a system and method for a group of co-inventors to negotiate their respective rights in a patent application.

To accomplish the above and other objects, a method is proposed, which, in the preferred embodiment, comprises the steps of creating a subscriber list; receiving a proposal of a patent idea by an initial inventor; creating a pool of potential co-inventors by searching through the subscriber lists; providing a forum for the pool of potential co-inventors and the initial inventor to communicate and further develop the patent proposal; soliciting bids on rights in the patent draft, once the patent proposal is ready to enter the drafting stage; allotting rights in the patent draft based on a process of bid, counter-bid, and response; writing, by members of the pool of co-inventors and the initial inventor, the patent draft based on the patent proposal; providing a forum for members of the pool of co-inventors and the initial inventor to communicate and further develop the patent draft; and ending the process, once it is determined that the patent draft is in condition to do so.

To accomplish the above and other objects, a system is proposed, which, in the preferred embodiment, comprises a network; a Subscriber database for storing subscriber records; a terminal by which an initial inventor transmits a patent proposal; a Patent Proposal Server for receiving the patent proposal, for creating a pool of potential co-inventors using the Subscriber Database, for storing a patent proposal file; a Patent Proposal Web Server for providing interactive access to the patent proposal file to the initial inventor and the pool of potential co-inventors; a Rights Negotiation Server for providing an interface that allows the initial inventor to solicit bids, create counter-bids, and receive responses; a Patent Draft Server for storing a patent draft file, once the rights in the patent draft have been determined; a Patent Draft Web Server for providing interactive access to the patent draft file to the initial inventor and the pool of co-inventors; and a Security System for maintaining appropriate levels of security.

### BRIEF DESCRIPTION OF THE DRAWINGS

The foregoing and other objects, aspects and advantages will be better understood from the following detailed description of preferred embodiments of the invention with reference to the following drawings:

FIG. 1 is a block diagram of the fundamental modules in the preferred embodiment of the present invention;

FIG. 2 is a flowchart of a method according to the preferred embodiment of the present embodiment;

FIG. 3 is a diagram of a system according to the preferred embodiment of the present embodiment;

FIG. 4 is a diagram of exemplary fields in a Non-Subscriber database record according to the preferred embodiment of the present invention;

FIG. 5 is an exemplary Co-Inventor Subscription web page according to the preferred embodiment of the present invention;

FIG. 6 is an exemplary Patent Proposal Input web page according to the preferred embodiment of the present invention;

FIG. 7 is a block diagram of the creation of a Patent Proposal Database record by components of a Patent Proposal Database Server according to the preferred embodiment of the present invention;

FIG. 8 is an exemplary Patent Proposal Pool web page according to the preferred embodiment of the present invention;

FIG. 9 is a flowchart of the steps in a rights negotiation procedure according to the preferred embodiment of the present invention; and

FIG. 10 is an exemplary Draft web page view of a Patent Draft File according to the preferred embodiment of the present invention.

### DETAILED DESCRIPTION OF THE PREFERRED EMBODIMENTS

In the following description, the terms “server” and “database” are used in a generic functional sense. The term “server” should be understood within the client/server architectural model—the client requests a service, the server provides a service. The term “database” can be understood in its most broad definition, as a data structure storing records. Thus, the servers and databases described below are not necessarily housed in different pieces of hardware. Indeed, any of the servers or databases could be implemented using a distributed network system, where the functional elements of a server or database are not only distributed among nodes, but will often migrate from node to node. On the opposite end of the spectrum, all of the servers and databases discussed below could be resident on one mainframe computer. However much of each server or database is implemented in software, firmware, or hardware is also open to many variations, as is well known in the art.

Furthermore, the terms “network” and “computer” are used in the most general sense. A “computer” is any computing means, from a single microprocessor or micro-controller to a computer system distributed over multiple processing nodes. A “network” includes any means that connects computers. Thus, although the preferred embodiment uses an Ethernet LAN, the nodes could connect to a central server through individual point-to-point connections. Other terms in the text are also to be understood in a generic functional sense, as would be known by one skilled in the art.

I. Overview

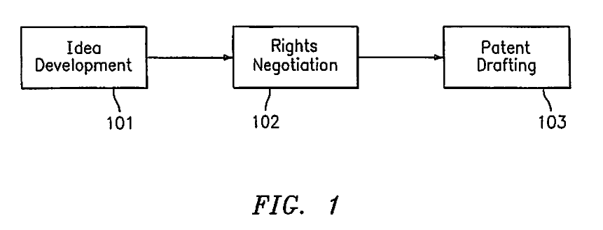

The procedure according to the preferred embodiment of the present invention can be broken down into three fundamental blocks, as shown in FIG. 1. The first stage, Idea Development 101, involves the proposal of an idea and the initial discussions concerning it, as the proposer of the idea assesses potential co-inventors and further fleshes out details. The first stage ends when the proposer selects her co-inventors. The second stage, Rights Negotiation 102, involves the negotiation between the proposer and the selected co-inventors over rights to the final patent, if it issues. What rights are being negotiated will depend on the circumstances of the co-inventors: employees of the same corporation might be negotiating over residual returns or bonuses given by the corporation, people previously unconnected by business ties might negotiate over rights in any patent that issues. When the group has reached a settlement, the third stage, Patent Drafting 103, begins. Patent Drafting 103 involves the collaboration of the group in drafting the patent.

Although these three different stages will be described in the preferred embodiment as being managed by one entity, each stage could be handled by a separate entity. In other words, in the preferred embodiment, a single corporation is managing all three stages for its own employees. However, these functions could be outsourced to a company whose business is directed towards managing one or more of an idea development system, a rights negotiation system, or a patent drafting system. Furthermore, each of these systems could be offered as a service on the Internet. In an Internet embodiment, people could subscribe to one or all of the services by paying a fee.

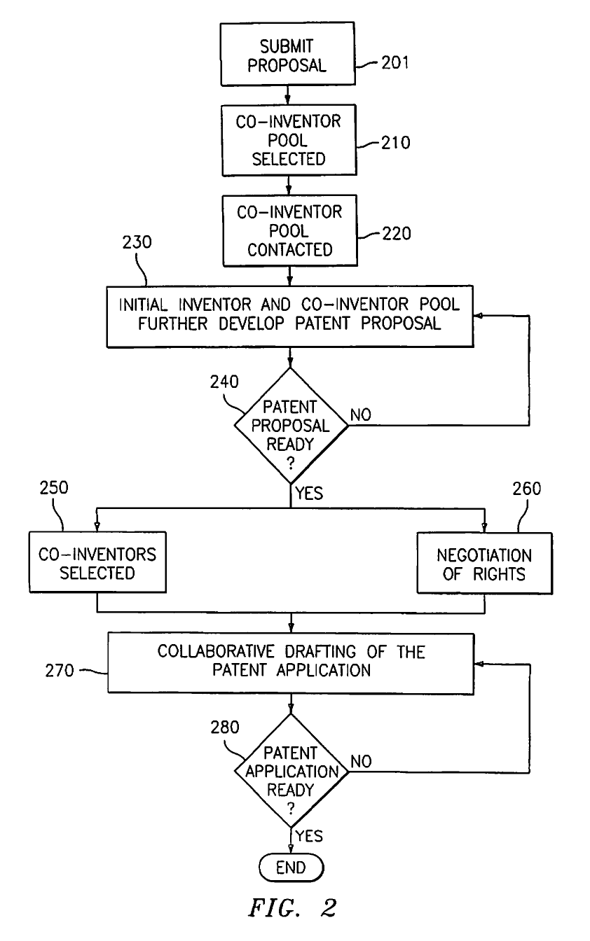

In the preferred embodiment, as discussed above, a single corporation is maintaining the three systems of FIG. 1. A general outline of the procedure according to the preferred embodiment is shown in FIG. 2. An initial inventor submits a patent idea and the requirements concerning possible co-inventors with whom to develop and write the patent in step 201. The “co-inventor pool”, those individuals with the appropriate confidentiality level and co-inventor requirements, are selected in step 210. In the preferred embodiment, a patent proposal committee determines whether it is worthwhile to go forward with the proposal before step 210. The members of the co-inventor pool are contacted with information concerning the patent proposal in step 220. In step 230, interested members of the co-inventor pool and the initial inventor provide suggestions, commentary and other material concerning the patent proposal, and this provided material is shared amongst one or more of the co-inventor pool. At step 240, the patent proposal committee determines whether the patent proposal is ready to enter the patent drafting stage. If it is, the final co-inventors need to be selected in step 250 and the rights of each of the co-inventors need to be determined in step 260. In the preferred embodiment, steps 250 and 260 occur simultaneously, which is why the steps are parallel to each other in FIG. 2. Once steps 250 and 260 are complete, the initial inventor and the co-inventors start the collaborative drafting of the patent application in step 270. A patent draft committee determines whether the patent draft is in final form in step 280. After this, the patent application is given to a patent agent to prepare for filing with a patent office.

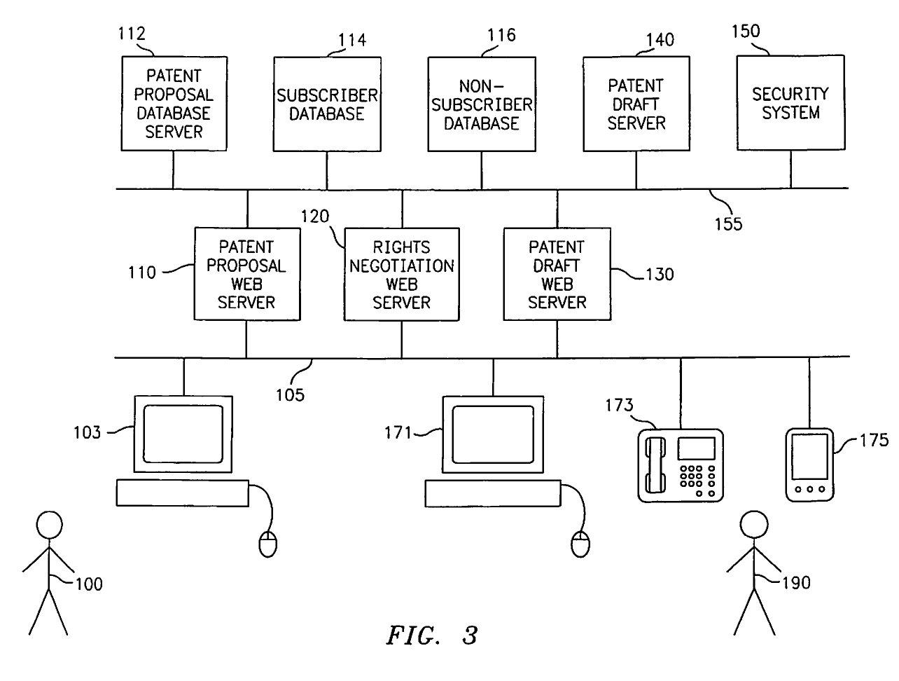

The system that performs these activities, according to the preferred embodiment of the present invention, will be described with reference to FIG. 3. The initial inventor, or patent proposer, 100 has a computer terminal 103, which is connected to the corporation's network 105. The terminal 103 is not necessarily on the corporation's grounds, and may be a home PC (personal computer) connected to the corporation's network 105 by a PPP (Point-to-Point Protocol) or SLIP (Serial Line Internet Protocol) connection. Computer 103 has a web browser program, such as Netscape Navigator™, installed.

The network is also connected to a Patent Proposal Web Server 110, a Rights Negotiation Web Server 120, and a Patent Draft Web Server 130. These three servers deal directly with Idea Development 101, Rights Negotiation 102, and Patent Drafting 103, respectively, as shown in FIG. 1. The Patent Proposal Web Server 110, Rights Negotiation Web Server 120, and Patent Draft Web Server 130 are also connected to a secured network 155. Also on the secured network 155 is a Patent Proposal Database Server 112, a Subscriber Database 114, a Non-Subscriber Database 116, a Patent Draft Server 140, and a Security System 150. As will become clear below, the secured network 155 is not necessary to the invention, if certain servers are directly connected to each other by, for instance, a serial connection.

As discussed above, according to the present invention, the different servers are not necessarily running on different processors and each individual server may be split up among multiple processors. In the preferred embodiment as shown in FIG. 3, there is a further separation between the elements that are directly accessible to the network 105 and the elements which are not. The three Web Servers 110, 120, and 130, are directly connected to the network; whereas the Patent Draft Server 140, Patent Proposal Database Server, Subscriber Database 114, non-Subscriber Database 116, and Security System 150 are only connected to the secured network 155. This is in order to provide greater security for subscriber, non-subscriber, and patent information. The Security System 150 maintains security and monitors the transmission of secured information to the Web Servers, as well as on the secured network 155 in general. The Security System 150 keeps records regarding confidentiality levels and authorized access to secured information. Each employee, or user of the corporate network 105, has a record in the Security System 150 describing their confidentiality level, login name, passwords, and event history. The Security System 150 ensures that only authorized personnel, including the initial inventor and the members of the pool of potential co-inventors, access particular web pages. Certain aspects of Security System 150 could also be implemented by storing the appropriate security information in different database records.

The Web servers provide access in browser format to this secured information, but a user of network 105 will not be able to directly access the secured information.

Although the preferred embodiment uses a web server, any network server system that provides individual files that can be accessed by different authorized groups could be used. In the preferred embodiment, the web servers act as an interface between the protected secured data in database form on the secured network 155 and the clients on the corporation's network 105 who are attempting to access that data. Other interface servers could be used rather than Web servers. The term “web servers” is to be understood as a World Wide Web-type server that delivers web pages to clients. The web pages are in HTML (Hypertext Mark-up Language), but could be in any mark-up language decipherable by the browsers being used on the network. In the preferred embodiment, data is retrieved from and posted to other servers using CGI (Common Gateway Interface).

In other embodiments, the separation between Web Server and Database or Draft Server may not be necessary. For instance, the secured databases may be directly accessible on a corporate intranet in a smaller corporation where the intranet is already reasonably secure. Furthermore, other means of accessing and sharing information on network 105 could be used besides Web Servers. Although the Patent Draft Server 140 and the Patent Proposal Database Server 112 are single units, both could be depicted as two units, one for storage, the other for processing. In other words, for instance, the Patent Proposal Database Server 112 could be depicted as a Patent Proposal Database for storage and a Patent Proposal Server for processing Patent Proposal Database records. For ease of explanation, these different functions have been integrated into one unit.

Other employees of the corporation have access to the network through a variety of means. As shown in FIG. 3, access may be through a terminal 171. Access can be made through embedded devices as well, such as a telephone 173, or a palm computer device 175. Wireless connections with network 105 could also be used, such a laptop with a radio connection to network 105.

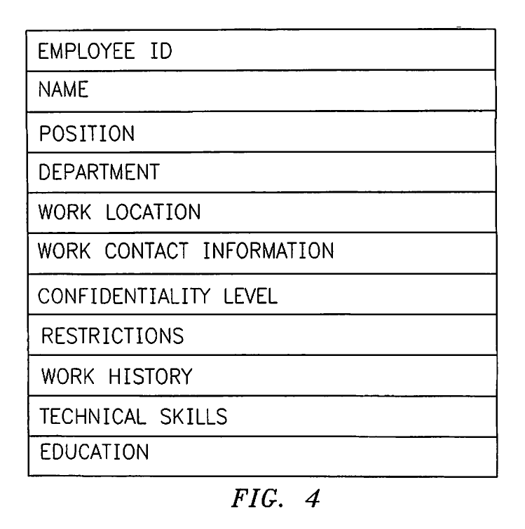

In the preferred embodiment, all employees of the corporation are listed in the non-Subscriber Database 116. In an Internet embodiment, the entries in the non-Subscriber database could be created from Internet websites, articles, and searches. FIG. 4 is an example of a non-Subscriber Database record. The non-Subscriber Database record contains fields for the employee's identification number, name, position, department (or division), work location, work contact information, assigned confidentiality level, restrictions, work history, technical skills, and education. The restrictions field contains information concerning access restrictions on the employee in addition to the confidentiality level. An example of such a restriction is if the employee is a citizen of another country for which there are access restriction laws. These fields are only examples, and the non-subscriber Database records may contain many more. For instance, if a corporation does a lot of government work, another field for a government security level would be included.

In the preferred embodiment, employees first sign up, or subscribe, to the patent drafting program in order to indicate their willingness to be a co-inventor. This sign-up procedure copies the non-subscriber record concerning the employee into a Subscriber database record. In the preferred embodiment, the employee uses a web browser program, such as Netscape Navigator™, to access and post information. Returning to FIG. 3, an employee 190 would enter the Patent Proposal Web Server and click on a “Subscribe?” button or a “Change Subscription Information?” button on the opening Web page. In this context, the terms “click” and “double-click” signify a user pressing the button on a mouse attached to a computer. However, any means of selecting and “pressing” screen icons using a cursor may be used. The employee is then asked for her name, employee id, and an access code. Because this information is being transferred over the corporation's network (or the Internet), a program layer operable in the browser and web server is used to encrypt and decrypt the information. In the preferred embodiment, SSL (Secure Sockets Layer), which uses a public and private key encryption system, is used to pass sensitive data between user terminals and the Web Servers. Furthermore, for the remaining description of the preferred embodiment, it is assumed that SSL is being used for communications between user terminals and Web servers.

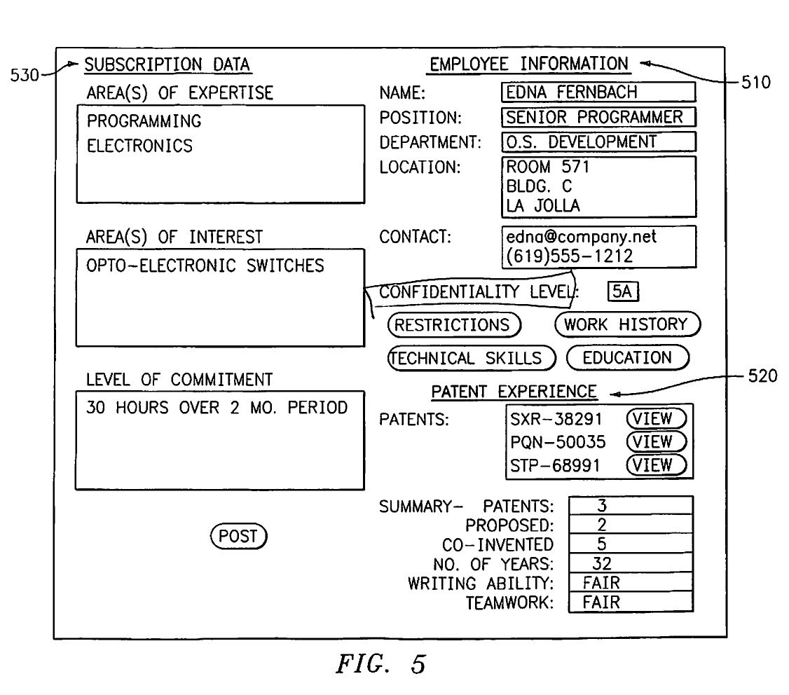

After the employee enters the login information, she is presented with a Co-Inventor Subscription Web page, as shown in FIG. 5. The Co-Inventor Subscription Web Page will present information already on file on the right-hand side, and fields to be filled in on the left-hand side. The “information already on file” includes the data in the employee's non-Subscriber Database record. On the right-hand side, Employee Information 510 lists information taken from the non-Subscriber Database record of the employee. Information fields that may be too large to show on the Web page are shown on separate pages or pop-up windows by pressing the appropriate button (“RESTRICTIONS”, “WORK HISTORY:, “TECHNICAL SKILLS”, and “EDUCATION” in FIG. 5).

Under Employee Information 510, is Patent Experience 520, which lists various aspects of the employee's patent experience. At the initial subscription of the employee, these fields may be empty, unless some of this information is stored in the non-Subscriber Database records. If the employee later accesses this page to change some data, these fields would be filled in. FIG. 5 shows the fields filled in, as an example. The first field in Patent Experience 520 in FIG. 4 is “Patents”, which lists all proposals, drafts, or issued patents the employee has worked on. This may or may not include patents worked on at other companies. The status (proposal, draft, filed, or issued) of the various patent projects can be indicated by color, icon, or other means common to the art of Web pages. In FIG. 5, the patent project worked on is listed by the corporation's identification (e.g., “SXR-38291”) and further information can be obtained by pressing the “View” button next to the identification. This button could lead to the actual Patent Draft file, which will be discussed further below, a summary, the issued patent, etc.

The second area in Patent Experience 520 after “Patents”, is the “Summary”, which consolidates certain statistics concerning the employee's patent work. FIG. 5 lists “Patents”, which is the number of drafts the employee has worked on, “Proposed”, which is the number of patent proposals the employee has made, “Co-invented”, which is the number of drafts on which the employee was a co-inventor, “No. of years”, which is the number of years the employee has been involved in patent drafting, “No. of hours”, which is the number of hours the employee has actually worked on patent drafting, “Writing Ability”, which rates the employee's patent drafting writing ability, and “Teamwork”, which is a measure of the employee's team work. None of these fields would be accessible (i.e. changeable) by the employee. Some fields, such as “Patents”, “Proposed”, “Co-Invented”, “No. of Years”, and “No. of Hours”, would be automatically generated. Other fields, such as “Writing Ability” and “Teamwork”, would require some sort of assessment. “Writing ability” could be determined by a designated reviewer, a patent draft committee, the patent agent who finalizes the patent drafts into applications, etc. “Teamwork” could be determined by other co-inventors, the initial inventor, a patent oversight committee, etc. Obviously, these fields (“Writing Ability” and “Teamwork”) are very sensitive, and, in other embodiments, they may not be viewed by the employee herself On the right-hand side of the Co-Inventor Subscription Web page, under “Subscription Data” 530 as shown in FIG. 5, are the fields that the employee enters herself. The first field “Area(s) of Expertise” allows the employee to list what she believes her areas of expertise. This is allowed in the preferred embodiment because another person with access to this record could view the employee's work history, technical skills, and education in order to assess the employee's claims of expertise. If the employee wishes, she may explain why those are her areas of expertise in the same field. The second field “Area(s) of Interest” allows the employee to indicate what area she wants to be further involved in. Putting a category like “Opto-Electronic Switches” in this field guarantees that, if the employee fulfills the other categories, the employee will be placed in the co-inventor pool for patent proposals involving opto-electronic switches. The third field “Level of Commitment” allows the employee to indicate how much time she is willing to expend as a co-inventor. This field could be highly detailed, supplying vacation times and differing numbers of hours for different weeks, or fairly vague, supplying a total number of hours for the whole project. In addition, the “Level of Commitment” could supply different amounts of time depending on the type of project.

Once these fields are filled, the Subscriber Database record is complete and stored in the Subscriber database 114. The records in the Subscriber Database 114 have many of the same fields as the non-Subscriber Database records, as shown in FIG. 4, but also has many additional fields, such as the fields under “Patent Experience” and “Subscription Data” in FIG. 5.

Having shown the types of files stored concerning subscribers and non-subscribers, the different aspects of Idea Development will be discussed in the section below.

II. Idea Development

As discussed in reference to FIGS. 2 and 3, the initial inventor 100 proposes a patent idea, by means of a computer 103, connected to the corporate network 105, in the preferred embodiment. When entering a patent proposal, the initial inventor accesses the opening web page of the Patent Proposal Web Server 110 and indicates that she wishes to propose a patent idea, which, for example, may be done by clicking on a “Proposal?” button. The employee is then asked for her name, employee id, and an access code, and, after the employee enters this information, is presented with a Patent Proposal Input Web page. As mentioned above, these communications between the browser client and the Web Server are encrypted using SSL. The Patent Proposal Input web page is used as an interface to create a new Patent Proposal database file in the Patent Proposal Database Server 112. The relationship between the Patent Proposal Input Page and the Patent Proposal Database record is analogous to the relationship between the Subscription Web Page and the Subscriber Database record described above. Therefore, the fields in an actual Patent Proposal Database record will not be discussed, because they correspond to the fields shown in a Patent Proposal Input Web Page.

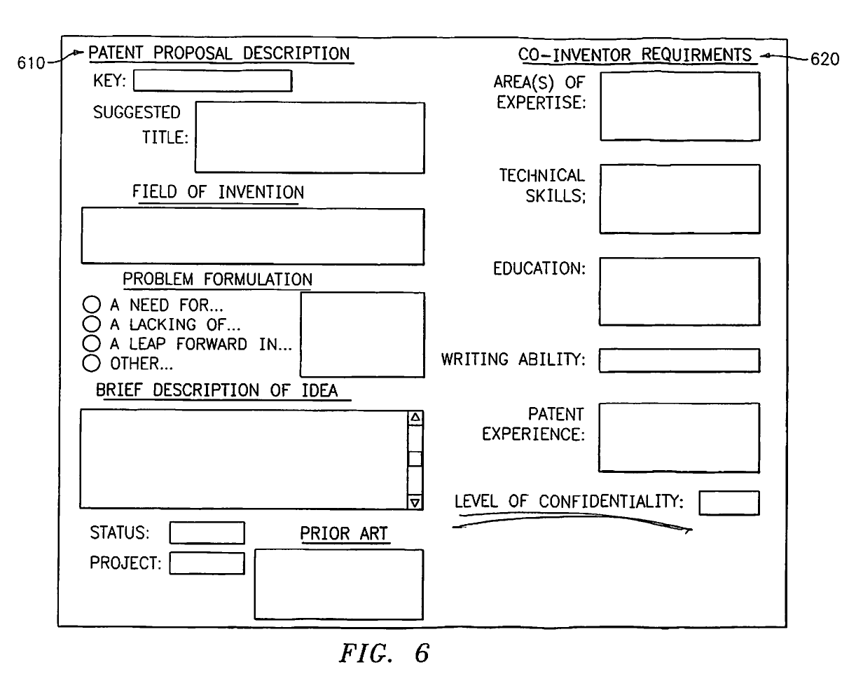

An example of a Patent Proposal Input Web page is shown in FIG. 6. The exemplary Patent Proposal Input Web page contains various fields, but some of them are optional, and more fields could easily be added. The fields on the left can be categorized as Patent Proposal Description fields 610 and the fields on the right as Co-Inventor Requirements fields 620.

Under the “Patent Proposal Description” in FIG. 6, the “Key” field would be the alphanumeric sequence used to identify this particular record. This would likely be generated by the system. The “Suggested Title” is the title proposed by the initial inventor. The “Field of the Invention” field gives one or more keywords or key phrases, such as “Drainage Equipment Improvement”, covering the area of the patent idea's application. The “Problem Formulation” field stores a short synopsis of the reasons or motivation for the patent idea. In order to make the system user-friendly, the problem formulation can have bullet categories to choose from, such as “a need for”, “a lacking”, or “a leap forward”, so that the user can quickly put the wording in proper form. The “Brief Description of the Idea” field gives enough information to inform the potential co-inventor pool of the broad outlines of the patent idea. This may include a general background of the invention, as well as a rough sketch of the particular inventive idea. A drawing scanned in by the initial inventor or a computer-generated graphic is also included to further illustrate the proposal. The “Prior Art” field describes previous equipment or inventions that are relevant to the present patent idea. The “Prior Art” field could also contain citations or links to articles or websites that are related to the patent proposal. The “Status” field indicates the stage of development the proposal is in, such as whether the Patent Proposal Committee has approved the patent idea to go forward to the collaborative stage. The “Project” field indicates a specific project this proposal is related to or part of. In other embodiments, the Database record would have additional fields and the ability to store various types of computer files related to the patent proposal, such as drawings, audio files, Internet links to related material, etc.

Under “Co-Inventor Requirements” in FIG. 6, are the requirements used to search the subscriber database to create the potential co-inventor pool. The “Level of Confidentiality” field stores the level of confidentiality determined by the Security System 150. In this example, the confidentiality levels are internal, confidential, and top confidential. However, there may be many more gradations and conditions in the confidentiality levels. The initial inventor can not modify this field. The “Area(s) of Expertise” field indicates the areas desired by the initial inventor. The “Technical Skills” field indicates what special skills or experience might be needed to assist in drafting the patent, such as a medical specialization. The “Education” field can indicate a level of education, type of education, or whether particular course or subjects were taken. The “Writing Ability” field indicates the appropriate level of writing aptitude desired in a co-inventor. The “Patent Experience” field indicates what level of previous experience in drafting patents is required in the co-inventor. There are many more possible co-inventor fields. They include a “Military-related” field, which is for people who do want to work on certain types of inventions, and a “Government Security” field, which could also be used in tandem with the “Level of Confidentiality” field for projects that require security clearance. A “Division” or “Location” field could indicate that the pool of co-inventors is limited to a division, department, or location within a corporation.

Most of these fields, except “Level of Confidentiality”, are filled in by the initial inventor in the preferred embodiment. In other embodiments, certain fields might be set by a patent proposal committee or patent proposal manager in order to ensure uniformity of style and that frivolous proposals are not made to subscribers. In yet other embodiments, all of the co-inventor qualifications could be determined by the corporation after the initial inventor submits the patent proposal. In further other embodiments, a patent proposal committee or patent proposal manager may give a final edit to the proposal before it is saved to the Patent Proposal database. Furthermore, the different fields could be weighted by their relative importance. For instance, if the “Technical Skills” were more important than the “Writing Ability” for this particular patent proposal, there would be additional fields applying weighing factors to the corresponding fields.

Returning to FIG. 3, after the initial inventor 100 inputs the appropriate information in the Patent Proposal Input Web page, the input information is transferred over the secure network 155 to the Patent Proposal database 112. At this point, the Patent Proposal Database Server 112 creates a Patent Proposal Database Record for this patent proposal. The Patent Proposal Database Server 112 is responsible for understanding the requirements sent by the initial inventor 100 and choosing which users to solicit with the patent idea. The Patent Proposal Database Server 112 uses the co-inventor requirements and patent proposal description to help select a solicitation list of possible co-inventors. The Security System 150 establishes a confidentiality level for each Patent Proposal record in the Patent Proposal Database Server 112, by determining the importance of the idea. The “importance” of an idea may have different meanings, depending on the corporation or entities involved. For instance, it may mean economic gain, level of need for that proposed idea in the corporation, and it may depend on other issues, such as whether or not the corporation is working with other corporations in the same area.

The Security System 150 may have a central processing unit (CPU) which uses a heuristic analysis program to weigh these factors and determine an appropriate confidentiality level. On the other hand, the Security System 150 may analyze the data and present a report to a patent proposal committee or patent proposal manager, who determines the appropriate level of confidentiality based on their knowledge of the situation and contact with other managers in the corporation. In short, the Security System 150 represents any type of system, computer or human, which designates a confidentiality level for a patent proposal.

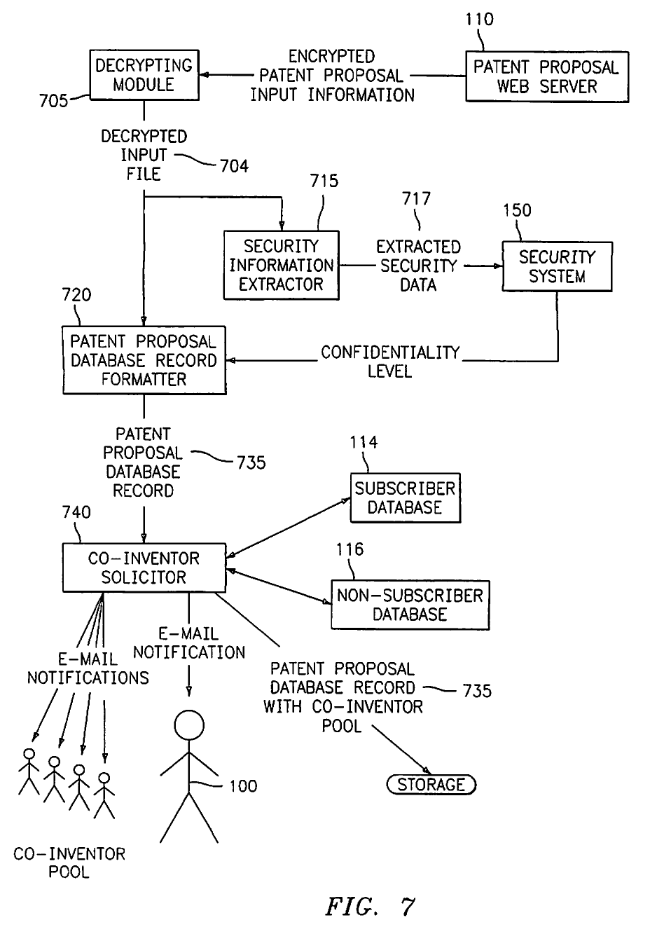

Now, the modules used by the Patent Proposal Database Server 112 to create a Patent Proposal Database record from the information received from the Patent Proposal Web Server 110 (the information input by the initial inventor 100) will be described in detail with reference to FIG. 7. The process begins when the patent proposal information input at the Patent Proposal Web Server 110 is sent to the Patent Proposal Database Server 112 over the secure network 155. In the preferred embodiment, this information is in encrypted form in order to ensure security. Because the information is encrypted, it is sent to a Decrypting Module 705, which decrypts the information, extracting the original data, which is patent proposal input file 704. The decrypted patent proposal input file 704 is sent to a Security Information Extractor 715, which extracts security information necessary for the Security System 150 to determine the appropriate level of confidentiality. This extracted information 717 is sent to the Security System 150. When the Security System 150 has finished its analysis, it sends the appropriate confidentiality level back to the Patent Proposal Database Server 112, where the Patent Proposal Database Record Formatter 720 receives it.

The Patent Proposal Database Record Formatter 720 receives the decrypted patent proposal file 704 and the confidentiality level, and combines the decrypted patent proposal input file, the confidentiality level, and other information into the appropriate record format of the Patent Proposal Database Server 112. This newly-created patent proposal database record 735 is sent to the Co-Inventor Solicitor 740, which selects potential co-inventors and solicits them. The Co-Inventor Solicitor 740 searches the Subscriber Database 114, and selects potential co-inventors using the co-inventor characteristics in the patent proposal database record 735. After searching the Subscriber database 114, the Co-Inventor Solicitor 740 searches the non-Subscriber Database 116 for potential co-inventors, using nominal characteristics from the patent proposal database record 735, such as “Technical Skills”, “Education”, etc. The Co-Inventor Solicitor 740 generates the co-inventor pool from these two searches and appends it to the database record 735.

At this point, the Co-Inventor Solicitor 740 accesses the contact information in the subscriber and non-subscriber database records to send an e-mail notification to each member of the co-inventor pool. The e-mail notification indicates that a patent proposal has been made and that the receiver should go to a link embedded in the e-mail message. This link will bring the receiver to a login web page on the Patent Proposal Web server, from which the receiver will enter a secured Patent Proposal Pool web page, which will be described below. Once the Co-Inventor Solicitor 740 has transmitted the e-mails to the co-inventor pool, it transmits an e-mail to the initial inventor 100, informing her that the co-inventor pool has been chosen and contacted. The subscriber could be contacted by an e-mail through the network 105, but may be contacted in other ways, such as by mail or bulletin. The message would also contain a link to the Patent Proposal Pool web page. At this point, the patent proposal database record 735 is stored.

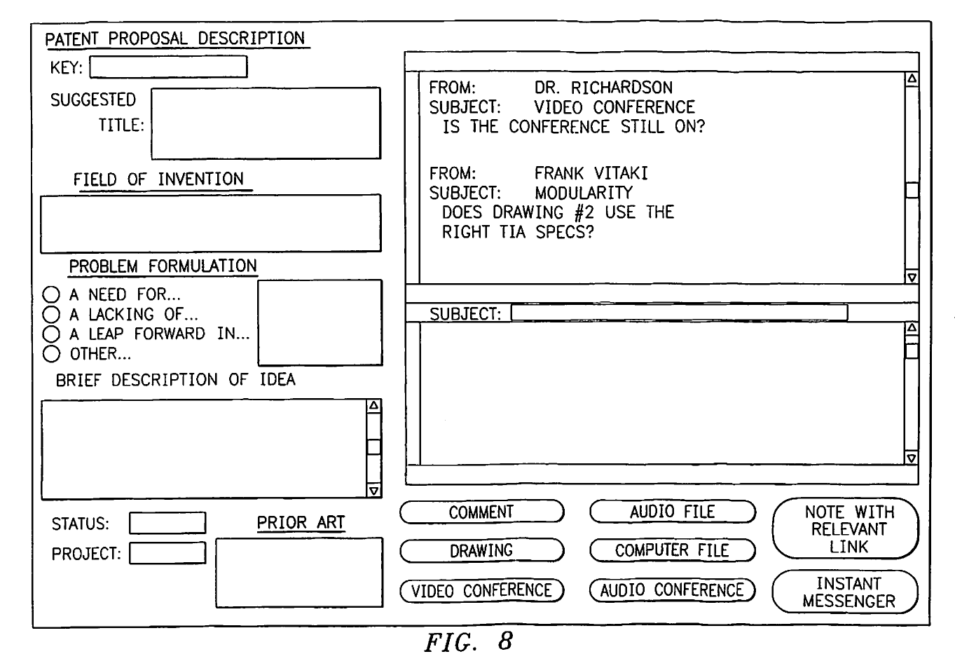

When either the initial inventor 100 or a member of the co-inventor pool goes to the Patent Proposal Pool web page, the Patent Proposal Web Server 110 will create the page by accesses the information contained in the corresponding patent proposal database record at the Patent Proposal Database Server 112. An example of a Patent Proposal Pool web page is shown in FIG. 8. In the preferred embodiment of the present invention, the left-hand side of the Patent Proposal web page is similar to the left-hand side of the Patent Proposal Input web page. Although the initial inventor 100 is able to modify the fields on the left-hand side, members of the co-inventor pool that access the page are not be able to modify those fields. On the right-hand side, the initial inventor 100 and members of the co-inventor pool can post messages, drawings, links, audio files, etc. As shown in FIG. 8, the right-hand side of the Patent Proposal Pool web page allows the user to choose the form of information she wishes to post to the web page by clicking on one of the buttons (“Comment”, “Drawing”, “Audio file”, “Computer file”, and “Note with relevant link”). In FIG. 8, the user has clicked the “Comment” button, and the right-hand side has filled with two sections corresponding to the “Comment” function. On the top is a list showing a shortened form of each “Comment” posted to this Patent Proposal Pool web page. On the bottom is a window for the user to enter her message to be posted. The Patent Proposal Pool web page in FIG. 8 also enables interactive communication between participants by clicking on the “Videoconference”, “Audio conference”, or “Instant Messaging”. Windows appropriate to each of those functions would appear on the right-hand side of the web page.

Many variations on the Patent Proposal Pool web page are possible. The initial inventor 100 might act as webmaster of the web page, capable of deleting posted information and altering the appearance of the web page. Furthermore, the initial inventor 100 could be empowered to remove members of the co-inventor pool. Posted information could have different levels of confidentiality so that, for example, project managers could post notes to each other concerning future business strategy, without necessarily informing all the members of the co-inventors pool.

In the preferred embodiment, the idea development stage ends when the patent proposal committee authorizes the proposal to enter the patent draft stage. In another embodiment, the initial inventor 100 decides when the patent proposal is ready to enter the draft stage. In yet another embodiment, the initial inventor 100 and the co-inventor pool reach a consensus as to when the proposal is ready to enter the draft stage. Furthermore, in other embodiments, the actual co-inventors may be chosen before entering the patent draft stage, so that the proposal may be more fully developed before determining whether it was worthwhile to enter the patent draft stage.

Having discussed the various aspects of Idea Development according to the preferred embodiment of the present invention, the stage of Rights Negotiation will be discussed in the section below.

III. Rights Negotiation

In the preferred embodiment, once the patent proposal committee has authorized a patent draft from the patent proposal, the co-inventors for the patent draft must be chosen. This choosing is done in concert with negotiating for the rights in any patent that issues from the draft. At this point, the Patent Proposal Database record concerning the accepted proposal is moved to the Patent Draft Server 140 over the secured network 155. The Patent Draft Server 140 has a higher level of security than the Patent Proposal Database Server 112, and holds all the active patent drafts. A corresponding patent draft file, which holds all the information from the originating Patent Proposal Database record as well as many new features, which will be discussed in the next section, is created.

In the preferred embodiment, rights negotiation is performed by means of the Rights Negotiation Web Server 120. The information used in and produced by the rights negotiation is stored in the Patent Draft file in the Patent Draft Server 140. In the preferred embodiment, there are several web pages employed in the rights negotiation stage. A Bidding web page is used by members of the pool of co-inventors to file their bids, which would be stored in the Patent Draft file on the Patent Draft Server 140. A Bid Analysis web page is used by the initial inventor to access all of the bids, and, in addition, may include embedded code for modeling different possible apportionments of rights in the patent draft. The embedded code, preferably in Java, would produce various models, such as pie charts, bar graphs, etc., representing different breakdowns of percentages according to the bids, counter-bids, or responses to counter-bids. The Bid Analysis web page also has a screen for viewing e-mail concerning the bidding from various parties.

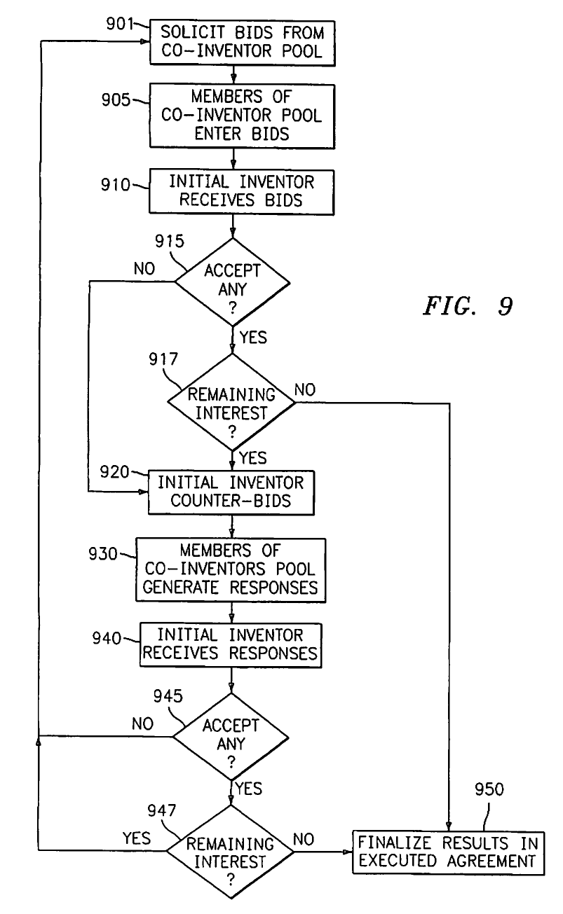

The steps in the rights negotiation process according to the preferred embodiment are shown in FIG. 9. In step 901, an e-mail soliciting bids for the patent draft are sent to all members of the co-inventor pool. The members of the co-inventor pool who are interested in developing the patent draft enter bids for their selection as a co-inventor in step 905. The nature of the bids will depend on the nature of the embodiment. For instance, the preferred embodiment is within a corporation that, presumably, wants the patent to be assigned to the corporation. Therefore, the interested members of the co-inventor's pool would not bid for an ownership interest in the patent itself. However, the corporation may assign a certain percentage of royalties generated by the patent to the inventors or bonuses to the inventors of certain important or successful patents. Hence, in the preferred embodiment, the bids of the interested members consist of the number of hours the potential co-inventor is willing to work on the project and the percentage of the potential benefits that the potential co-inventor would want based on those hours. In an Internet embodiment, where the parties are only connected by the web page, the bid may be a straight percentage of any monies that result from any issued patent.

In the preferred embodiment, the initial inventor receives the various bids in step 910 and determines whether to accept any of the bids in step 915. In other embodiments, the initial inventor and the interested participants would bid against each other to a patent draft committee, which would perform the tasks performed by the initial inventor in the preferred embodiment. In the preferred embodiment, the bids are “sealed”, meaning the interested members of the co-inventor pool do not know what the other members have bid. If the initial inventor does accept any of the bids in step 915, it is determined whether all of the rights in the patent draft have been assigned in step 917. If all the rights have been allotted, the results of the bidding are finalized in an executed agreement in step 950. If interests in the patent draft remain unallotted in step 917, or the initial inventor does not accept any bids in step 915, the initial inventor counter-bids in step 920. The members of the co-inventor pool still interested in bidding enter responses to the counter-bid in step 930. The initial inventor receives the responses to the counter-bids in step 940 and determines whether to accept any of the responses to the counter-bids in step 940. If the initial inventor does not accept any of the responses, the process starts over at step 901. If the initial inventor accepts some of the responses to the counter-bid in step 945, it is determined whether there is a remaining interest in the patent draft in step 947. If there is, the process returns to step 901, and bids are solicited from the remaining participants. If the interests in the patent draft have been exhausted in step 947, the initial inventor and the chosen co-inventors finalize the results in the form of an executed agreement in step 950.

In another embodiment, the co-inventors could be chosen first, and then bid between themselves for their percentage of benefits accruing from the patent draft. In a further embodiment, the chosen co-inventors would not have the ability to drop out of the bidding. In other words, the co-inventors in that embodiment have been effectively assigned the patent draft as a project, but still can determine their interest in it.

In addition, the Patent Proposal Database record is not transferred to another server in another embodiment, but remains in one server through all the stages, merely increasing its security level when it become a patent draft file.

There are many possible variations on the Rights Negotiation stage. It could be performed by consensus between the chosen co-inventors and the initial inventor. The initial inventor may choose what form of bargaining will be used in this stage in her initial Patent Proposal Input. The results of the rights negotiation, as well as the executed agreement, is stored in the new Patent Draft file in the Patent Draft Server 140.

Having discussed the various steps of Rights Negotiation according to the preferred embodiment of the present invention, the stage of Patent Drafting will be discussed in the section below.

IV. Patent Drafting

Once rights in the patent draft have been apportioned, the actual drafting of the patent begins. As previously mentioned in section III, there is a Patent Draft file on the Patent Draft Server 140. The inventor group, consisting of the initial inventor and the final co-inventors, access and interact with the file through the Patent Draft Web Server 130, which has a higher level of security than the Patent Proposal Web Server 110.

In the preferred embodiment, a network user would discover a “login” opening web page when attempting to access a Patent Draft file. The login procedure involves a simple name/password combination, but, in other embodiments, the procedure could be complex as the relevant art allows. After the login procedure, relevant data or notes concerning the patent draft will be displayed as well as buttons leading to various “views”, web pages that interact or display the Patent Draft file in different ways.

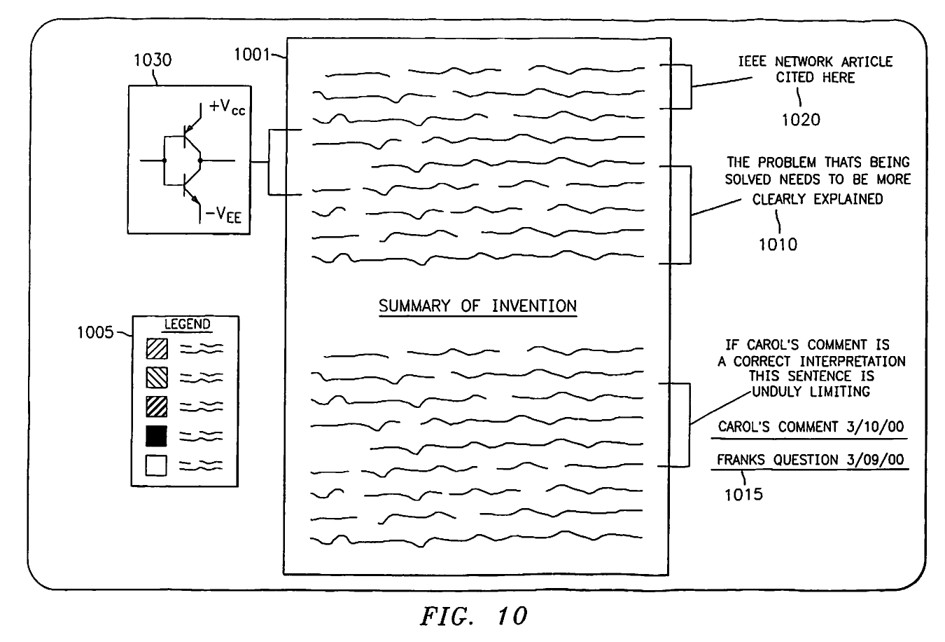

A “Draft View” will be described with reference to FIG. 10. In this view, the actual draft of the document is in the center of the screen, as shown by reference number 1001. The draft, and interaction with the draft, is similar to any word-processing program, such as MS Word or WordPerfect. In the text of the draft, the authorship of sentences and paragraphs is indicated by color, and the color legend is in the lower left-hand corner, as indicated by reference number 1005. In other words, a person looking at this view could tell that co-inventor B wrote the second paragraph on the page because the text of the second paragraph is in red, and the color legend 1005 indicates that red text was entered by co-inventor B on November 3, at 3 p.m. The color legend 1005 will change page by page so as to allow the most flexibility.

Furthermore, members of the inventor group can post messages and comments in the “margin”, the area to the left and right of the draft. A comment could refer to a particular section in the draft, as does the comment indicated by reference number 1010. A comment could also be a link to a relevant reference, as shown by reference number 1020. Comments may result in replies, which may result in counter-replies, and so on. In order that the user has access to the history of commentary regarding a passage or general aspect of the draft, the preferred embodiment uses links, as indicated by reference number 1015. 1015 indicates a comment followed by several links, where each link opens up the complete text of a previous comment. The text could open up into the margin, or be in a pop-up window. The links themselves can appear as text indicating the author/date/time, or subject matter. In other embodiments, a scroll window could be used in order to scroll between messages in that message thread. Drawings, diagrams, graphics or pictures, such as diagram 1030, can also be posted in the margin. In order to get a better view of diagram 1030, a user would double-click on it and a larger sized diagram would form in a pop-up window. Almost any type of file that is storable on computer could be posted in the margins. Again, it should be noted that different levels of confidentiality could be applied to the posted materials, allowing some members of the inventor group to view some posted material while others could not.

There is also a Contributions view that displays the amount of time each member of the inventor group has spent on the draft, as well as the quantity of writing each member has supplied. In the preferred embodiment, this view can be accessed by the entire inventor group and other authorized individuals, but, in other embodiments, it can be restricted to the initial inventor and authorized individuals. The Contributions view shows when each member of the inventor group worked, and what exactly they did. Different types of analysis may be performed in the Contribution view, in much the same manner as the Bid Analysis web page.

A Meeting view is used for interactive meetings between members of the inventor group and authorized individuals. This view enables any of the means for interactive communication using a network, including instant messaging, videoconferencing, and audio conferencing. In the preferred embodiment, the members of the meeting can determine whether to display the Draft view on the computer screen simultaneously with the Meeting view, which would then take the form of an inset window. Meetings would be recorded and archived. If members of the inventor group meet in person to discuss the draft, the meeting could be recorded and archived as well. The archives would be accessible through the Meeting view. Again, it should be noted that different levels of confidentiality could be applied to participation in meetings and access of archives.

In the preferred embodiment, the patent drafting committee determines when the draft is in condition to be sent to be filed as a patent application or to a patent agent for preparation for filing as a patent application. In other embodiments, the inventor group may decide when the draft is ready by consensus or the initial inventor may have that power. It is also possible to have management personnel make this decision. In an Internet embodiment, the company that is supplying the patent drafting facility may provide an overseer who determines when the patent draft is ready, and who could indicate what needs to be done to put in proper form. Furthermore, in an Internet embodiment, the draft may be turned over to a patent agent for final preparation and review.

Several of the advantages of the preferred embodiment of the present invention are clarified by the above description. First, the preferred embodiment enables individuals to collaborate over long distances. Besides the clear application to Internet collaboration, this ability is especially helpful for multinational corporations which have campuses throughout the world. Second, the members of the inventor group will not have to leave their computer in order to interact with others in the inventor group. This means time will not be wasted traveling to and from meetings, or waiting to discuss issues with others working on the patent draft.

As mentioned in section 1, the different components in FIG. 3 can be understood as functional modules, which can be combined or further divided as necessary for implementing a particular embodiment. The functions may be implemented in software or hardware. Furthermore, certain procedural steps may be performed in a different sequence, according to the needs of different embodiments.

Although all three stages are performed by means of computers on a network in the preferred embodiment, one or more of the stages of the present invention could be performed through non-computer means. For example, the Rights Negotiation stage could be performed in person at a meeting of the initial inventor and the co-inventor pool.

Furthermore, the Rights Negotiation stage could be performed more than once in other embodiments. In other words, there could be an initial negotiation when the inventor group is chosen and then a final negotiation when the draft is finished, when an analysis of each individual's contribution could be made. In further embodiments, there might be no Rights Negotiation stage, and the various interests in the patent draft would be assigned by management or determined by the positions of the individuals within the corporation.

While the present invention has been described with respect to certain preferred embodiments, it should be understood that the invention is not limited to these particular embodiments, but, on the contrary, the invention is intended to cover all modifications, equivalents, and alternatives falling within the spirit and scope of the invention as defined by the appended claims.

What is claimed is:

1. A method for supporting the development of inventions by a plurality of inventors, said inventors using at least one computing device connected in a network, the method comprising the steps of:
generating by a first computing device a subscriber list, said subscriber list including subscriber records of subscribers, each of said subscriber records having at least a subscriber name, subscriber contact information, and subscriber qualifications;
storing said subscriber list in a database;
receiving by the first computing device a proposal for an invention from an initial inventor, said proposal including desired co-inventor qualifications;
determining by the first computing device subscribers having subscriber qualifications matching the desired co-inventor requirements by searching the subscriber records in the subscriber list; and
generating by the first computing device a pool of co-inventors, said pool of co-inventory includes subscribers determined to have subscriber qualifications matching the desired co-inventor requirements,
wherein said co-inventors in said pool assist the initial inventor in developing the invention described in the proposal for invention.

2. The method as recited in claim 1, wherein the proposal for invention is transmitted over the network, wherein at least one of said plurality of computing devices is used by the initial inventor and at least one of said plurality of computing devices is used for receiving the proposal for invention.

3. The method as recited in claim 1, further comprising contacting via electronic means the subscribers in the pool of co-inventors.

4. The method as recited in claim 1, wherein the developing of the invention is performed over the network, each of said plurality of computing devices being accessible by one or more subscribers in the pool of co-inventors.

5. The method as recited in claim 1, wherein the step of generating a subscriber list comprises:
contacting, by an individual using a computing device, a Subscriber Database;
creating a subscriber record for the individual on the Subscriber Database;
inputting, by the individual, information including a name of the individual, contact information of the individual, and qualifications of the individual into the subscriber record; and
storing the subscriber record on the Subscriber Database.

6. The method as recited in claim 1, further comprising providing a confidentiality level associated with each corresponding subscriber.

7. The method as recited in claim 1, further comprising establishing a level of confidentiality for the proposal for invention.

8. A computer system for supporting the development of inventions by a plurality of inventors, said inventors using at least one computing device connected in a network, the computer system comprising:
at least one computer readable memory including:
code for generating by a first computing device a subscriber list, said subscriber list including subscriber records of subscribers, each of said subscriber records having at least a subscriber name, subscriber contact information, and subscriber qualifications;
code for storing said subscriber list in a database;
code for receiving by the first computing device a proposal for an invention from an initial inventor, said proposal including desired co-inventor qualifications;
code for determining by the first computing device subscribers having subscriber qualifications matching the desired co-inventor requirements by searching the subscriber records in the subscriber list; and
code for generating by the first computing device a pool of co-inventors, said pool of co-inventory includes subscribers determined to have subscriber qualifications matching the desired co-inventor requirements,
wherein said co-inventors in said pool assist the initial inventor in developing the invention described in the proposal for invention.

9. The system as recited in claim 8, wherein the proposal for invention is transmitted over the network, wherein at least one of said plurality of computing devices is used by the initial inventor and at least one of said plurality of computing devices is used for receiving the proposal for invention.

10. The system as recited in claim 8, further comprising code for contacting via electronic means the subscribers in the pool of co-inventors.

11. The system as recited in claim 8, wherein the developing of the invention is performed over the network, each of said plurality of computing devices being accessible by one or more subscribers in the pool of co-inventors.

12. The system as recited in claim 8, wherein code for generating a subscriber list comprises:
code for contacting, by an individual using a computing device, a Subscriber Database;
code for creating a subscriber record for the individual on the Subscriber Database;
code for inputting, by the individual, information including a name of the individual, contact information of the individual, and qualifications of the individual into the subscriber record; and
code for storing the subscriber record on the Subscriber Database.

13. The system as recited in claim 8, further comprising code for providing a confidentiality level associated with each corresponding subscriber.

14. The system as recited in claim 8, further comprising code for establishing a level of confidentiality for the proposal for invention.
